(19) United States
(12) Patent Application Publication
(10) Pub. No.: US 2005/0133325 A1
(43) Pub. Date: Jun. 23, 2005

(54) Dynamic damper

(75) Inventors: Naohito Kuwayama, Nagoya-shi (JP); Takashi Hayashi, Komaki-shi (JP)

Correspondence Address: OLIFF & BERRIDGE, PLC, P.O. BOX 19928, ALEXANDRIA, VA, 22320, US

(73) Assignee: TOKAI RUBBER INDUSTRIES, LTD., Komaki-shi (JP)

(21) Appl. No.: 11/009,151

(22) Filed: Dec. 13, 2004

(30) Foreign Application Priority Data
Dec. 19, 2003 (JP) 2003-421867

(51) Int. Cl. F16F 5/00

(52) U.S. Cl. 188/379

(57) ABSTRACT

A dynamic damper including a rubber elastic body interposed between and connecting an inner sleeve mounted at one end on a flat attachment surface of an object member and a cylindrical mass member disposed coaxially about the inner sleeve with a spacing therebetween, and an annular flange extending radially outwardly from the one end of the inner sleeve. When the dynamic damper is mounted on the attachment surface, an outer rim of the one end of the inner sleeve is surrounded by an outer rim of an area of the attachment surface where is superimposed with the flange.

### INCORPORATED BY REFERENCE

The disclosure of Japanese Patent Application No. 2003-421867 filed on Dec. 19, 2003 including the specification, drawings and abstract is incorporated herein by reference in its entirety.

### BACKGROUND OF THE INVENTION

1. Field of the Invention

This invention relates to dynamic dampers in which a metallic inner sleeve and a mass member are elastically connected together via an rubber elastic body, and one axial end of the inner sleeve is affixed to a flat attachment surface of an object member such as a vehicle transmission, a center bearing, and the like.

2. Description of the Related Art

JP-A-2003-4095 discloses one example of conventional dynamic dampers of this type, which includes: a metallic inner sleeve having a cylindrical part and an annular flange protruding radially outwardly from one axial end of the inner sleeve; a metallic outer sleeve disposed coaxially about the inner sleeve and having an annular flange protruding radially outwardly from one end in the axial direction; an elastic body interposed between the inner and outer sleeves; and a mass member press fitted onto an outer circumferential surface of the outer sleeve. This dynamic damper is affixed to an object member such that the dynamic damper protrudes from the installation part, which encloses a plurality of leaf spring bushings, and is fixed by an installation shaft part that passes through an shaft hole of the inner sleeve so that the axial direction of the inner sleeve is oriented in the vertical direction. This dynamic damper is affixed to the object member with its axial direction oriented in the vertical direction of the vehicle, and is provided with an increased spring constant in its axial direction, which may be provided by disposing the annular flanges of the inner sleeve and the mass member opposed to each other, or alternatively by providing a separate stopper plate to the one end of the cylindrical part of the inner sleeve to be opposed to the annular flange of the mass member, thereby putting the rubber elastic body into a condition of compression or tension. Thus, the resonance frequency of the dynamic damper is increased in the vertical direction, making it possible to damp high frequency vibration within a limited space without increasing the mass of the mass member.

To keep pace with growing requirements for vehicle quietness, there is a demand for a dynamic damper capable of damping vehicle lateral vibration in addition to high frequency vertical vibration. However, since the conventional dynamic damper is affixed to the object member at an end face of the one axial end of the inner sleeve, the inner sleeve has low yield strength with respect to lateral load and is apt to be bent. As a result, this dynamic damper is not able to increase its resonance frequency as the spring constant of the rubber elastic body increases, thereby being incapable of damping high frequency lateral vibration. JP-A-2000-337431 and JP-U-1-146025 disclose dynamic dampers with similar structures, and these have the same defects as in the dynamic damper of JP-A-2003-4095.

Moreover, the conventional dynamic damper as disclosed in JP-2003-4095, is typically installed on the object member via a mounting member having a mounting plate part with a bolt hole perforated therethrough. A front surface of the mounting plate provides the attachment surface onto which the axial end of the inner sleeve of the dynamic damper is attached, and a gap is formed on the back surface side of the mounting plate for accommodating a bolt head inserted through the bolt hole of the mounting plate and the bore of the inner sleeve for fixing the inner sleeve onto the mounting plate. Namely, the gap is formed between the mounting member and the object member, which may be filled with a rubber elastic body as needed. However, the presence of the gap behind the attachment surface further decrease the strength of the attachment surface rigidity, possibly causing bent or deformation of the inner sleeve. Furthermore, the annular flanges of the inner sleeve or a stopper plate is provided at the distal end portion of the inner sleeve of the dynamic damper, the basal end of the inner sleeve inevitably experiences greater moment, thus further increasing possibility of bent of the inner sleeve.

### SUMMARY OF THE INVENTION

It is therefore one object of this invention to provide a dynamic damper in which the spring constant can be tuned to lateral vibration of a vehicle in addition to the vertical vibration, and in which vibration in both directions can be controlled by transferring bi-directional resonance frequencies to the high frequency end, thereby improving vehicle quietness.

The above and/or other objects may be attained according to at least one of the following modes of the invention. The following preferred modes of the invention may be adopted at any possible optional combinations. It is to be understood that the present invention is not limited to the following forms or combinations of these forms, but may otherwise be recognized based on the thought of the present invention that described in the whole specification and drawings or that may be recognized by those skilled in the art in the light of the disclosure in the whole specification and drawings.

One mode of the invention provides a dynamic damper including: an inner sleeve adapted to be mounted at one axial end thereof on a flat attachment surface of an object member; a cylindrical mass member disposed coaxially about the inner sleeve with a spacing therebetween; a rubber elastic body interposed between and elastically connecting the inner sleeve and the mass member; and an annular flange extending radially outwardly from the one axial end of the inner sleeve, wherein when the dynamic damper is mounted on the attachment surface, an outer rim of the one axial end of the inner sleeve is surrounded by an outer rim of an area of the attachment surface where is superimposed on the flange.

In the invention as constituted above, the annular flange is provided extending radially outwardly from the one axial end of the inner sleeve, and the flange of the inner sleeve is installed onto the attachment surface of the object member. Moreover, the one axial end of the inner sleeve not including the flange is surrounded by the outer rim of the area of the attachment surface where is superimposed on the flange. Thus, by increasing the contacting surface area between the inner sleeve and the object member, the inner sleeve is firmly attached and is supported by the object member so that the inner sleeve yield increased strength relative to input vibration perpendicular to its axis is increased. As a result, since the dynamic damper is installed so that it is axially oriented relative to the vertical direction of the vehicle, the resonance frequency of the dynamic damper can be maintained at the preset value without any decrease relative to lateral input vibration. Thus, the dynamic damper of the present invention ensures appropriate resonance frequency settings in the lateral direction, in addition to the vertical direction, thereby affording appropriate vibration damping performance with respect to high frequency vibration in two directions, i.e., vertical and lateral, resulting in a significant improvement in vehicle quietness.

In the dynamic damper according to another mode, the mass member may comprise a lightweight cylinder sleeve and an outer cylinder mass having a greater weight than does the cylinder sleeve, and externally fitted onto the cylinder sleeve. Thus, when the mass of the mass member is extremely heavy, it can be divided into a light-weight cylinder sleeve and an outer cylinder mass that is of greater weight than the inner sleeve, and after vulcanizing the rubber elastic body interposed between the inner sleeve and the lightweight cylinder sleeve, the vulcanized product can be installed into the bore of the outer cylinder mass. As a result, the rubber elastic body can easily be vulcanized, and the overall manufacture of the dynamic damper is simplified, including the installation of the inner and outer cylinder masses, and a dynamic damper can be provided at low cost.

According to yet another mode of the invention, an inner rim of the mass member may be surrounded by an outer rim of the flange. By surrounding the inner rim of the mass member by the outer rim of the flange as described above, it is possible to enlarge the contacting surface between the flange and the attachment surface of the object member, thereby firmly fixing the flange to the object member. As a result, the strength of the inner sleeve in relation to lateral force is increased, making it possible for the dynamic damper to provide enhanced damping performance for high frequency lateral input vibration.

According to still another mode of the invention, the rubber elastic body may be interposed between the opposing surfaces of the mass member and the flange. With the rubber elastic body interposed between the opposing surfaces of the mass member and the flange, compressive deformation of the rubber elastic body may be utilized in addition to shear deformation of the rubber elastic body, making it possible to adjust the spring constant of the rubber elastic body within a wide range. Thus, the present dynamic damper may be suitably adjusted in terms of damping of up and down as well as side-to-side vehicle vibration.

According to a further mode of the invention, an entire outer surface of the mass member may be coated with a rubber coating layer, and the mass member may be made non-adhering with the rubber elastic body and the rubber coating layer. Thus, by making the mass member non-adhering with the rubber elastic body and the rubber coating layer, manufacturing costs of the dynamic damper can be reduced because the adhesive processing step for the inner sleeve and the mass member in the rubber vulcanizing operation may be omitted.

According to a yet further mode of the invention, this dynamic damper the dynamic damper can be arranged such that the resonance frequencies in axial and axis-perpendicular directions thereof are tuned to different frequencies. With the resonance frequencies in the axial and axis-perpendicular directions tuned to different frequencies, the dynamic damper is capable of providing appropriate damping performance with respect to vertical and lateral input vibration of the vehicle.

According to a stiff further mode of the invention, a mounting member for mounting the dynamic damper on the object member is further included. The mounting member includes a mounting plate part having a hole perforated therethrough. The flat attachment surface is provided on one side of the mounting plate part, and a gap is formed on an other side of the mounting plate part for accommodating a head of a fixing member extending through the hole of the mounting plate part and an inner bore of the inner sleeve for affixing the inner sleeve onto the flat attachment surface provided by the mounting plate part of the mounting member, and the annular flange is superimposed on the attachment surface provided by the mounting plate part of the mounting member. With this arrangement, the annular flange functions as a reinforcing plate, thereby increasing rigidity or strength of the mounting plate part, while the contacting surface area between the flange and the attachment surface is made large, as compared with the contacting surface area between the one end of the inner sleeve and the attachment surface, so that load exerted on the basal end of the inner sleeve is effectively dispersed. Thus, by means of the flange functioning as the reinforcing plate, the attachment surface of the mounting member is reinforced, thereby preventing bent of the inner sleeve.

With this invention, by firmly fixing the inner sleeve to the attachment surface of the object member with the flange, the inner sleeve is supported by the object member with increased strength to resist lateral forces from input vibration in the axis-perpendicular direction, thereby preventing a reduction in the dynamic damper resonance frequency relative to input vibration in the axis-perpendicular direction. This invention, accordingly, permits appropriate settings for biaxial resonance frequencies in the axial and axis-perpendicular directions, so that the present dynamic damper exhibits appropriate damping performance for high frequency vehicle vibration in the vertical and lateral directions, thereby achieving a significant increase in vehicle quietness.

Furthermore, since the mass member may be formed as a combination of the lightweight cylinder sleeve and the outer cylinder mass that is heavier than the cylinder sleeve, vulcanizing formation of the rubber elastic body is very much easier so that a dynamic damper can be produced at lower-cost. Moreover, by enclosing the inner rim of the mass member with the outer rim of the flange, the strength of the inner sleeve in relation to lateral force is further increased, whereby the dynamic damper is capable of appropriately damping vibration in its lateral direction. Further, by providing rubber elastic body interposed between the opposing surfaces of the mass member and the flange, the compressive deformation of the rubber elastic body in addition to its shear deformation can be utilized, whereby the spring constant of the dynamic damper can be adjusted over a wide frequency range, resulting in further enhanced damping performance with respect to up and down as well as side-to-side vehicle vibration.

Also, in this dynamic damper rubber vulcanization formation is simplified and dynamic damper manufacturing costs reduced by the fact that the mass member is made non-adhering to the rubber elastic body and the rubber coating layer. Moreover, by tuning frequencies of the dynamic damper in the vertical direction and the perpendicular direction to different resonance frequencies, the appropriate amount of control of high frequency vehicle input vibration in the up-and-down and side-to-side directions can be affected, and a significant increase in vehicle quietness can be obtained.

Since the mass member is made non-adhering with the rubber elastic body and the rubber coating layer, the rubber vulcanization process is simplified and dynamic damper manufacturing costs is reduced. Moreover, by tuning frequencies of the dynamic damper in the vertical direction and the lateral direction to different resonance frequencies, the dynamic damper is able to afford appropriate damping performance for high frequency vehicle vibration in the up-and-down and side-to-side directions, thereby achieving a significant increase in vehicle quietness.

### BRIEF DESCRIPTION OF THE DRAWINGS

The forgoing and/or other objects features and advantages of the invention will become more apparent from the following description of a preferred embodiment with reference to the accompanying drawings in which like reference numerals designate like elements and wherein:

FIG. 1 is an elevational view in axial or vertical cross section of a dynamic damper of construction according to a first embodiment of the invention, taken along line 1-1 of FIG. 2;

FIG. 2 is a side elevational view of the dynamic damper of FIG. 1;

FIG. 3 is an axial cross sectional view of a rubber bushing of the dynamic damper of FIG. 1;

FIG. 4A is a front elevational view of a mass member of the dynamic damper of FIG. 1, and FIG. 4B is a bottom plane view of the mass member of the dynamic damper of FIG. 1;

FIG. 5A is a cross sectional view of a mounting member of the dynamic damper of FIG. 1, taken along line 5-5 of FIG. 5B, and FIG. 5B is a side elevational view of the mounting member of FIG. 5A;

FIG. 6 is an elevational view in axial or vertical cross section of a dynamic damper of construction according to a second embodiment of the invention, taken along line 6-6 of FIG. 7;

FIG. 7 is a top plane view of the dynamic damper of FIG. 6;

FIG. 8 is an axial cross sectional view of the dynamic damper of FIG. 6 in a state installed on an object member;

FIG. 9 is an axial cross sectional view of a modification of the dynamic damper of FIG. 8; and

FIG. 10 is an elevational view in axial or vertical cross section of a dynamic damper of construction according to a third embodiment of the invention.

### DETAILED DESCRIPTION OF PREFERRED EMBODIMENTS

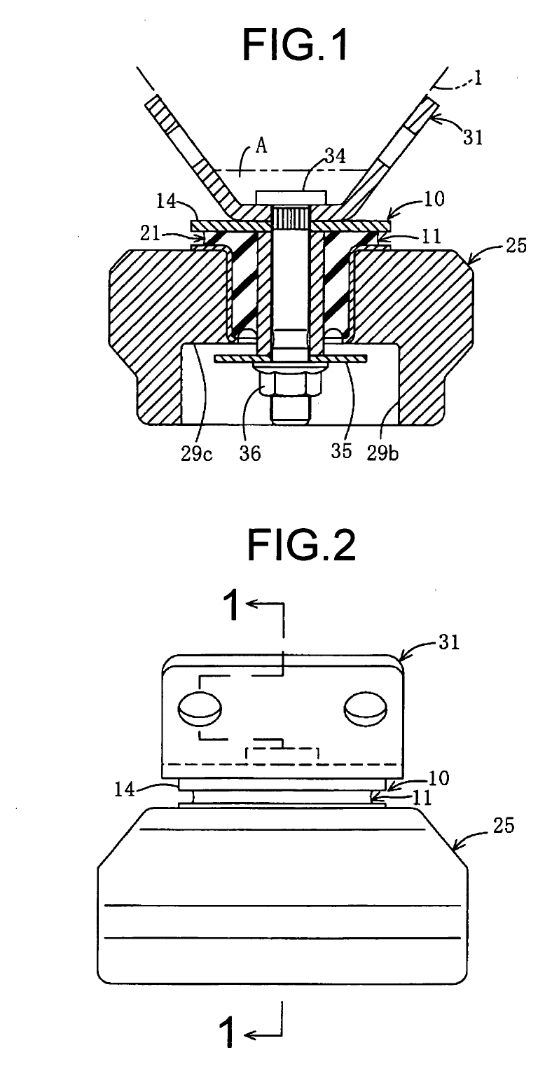

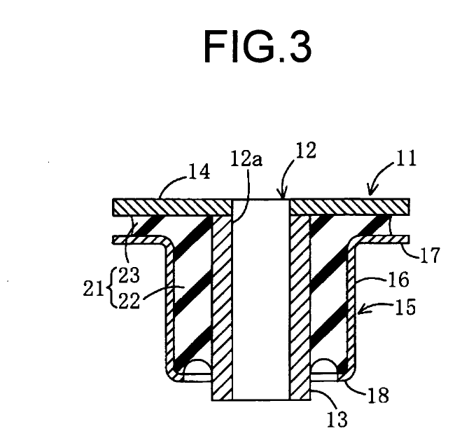

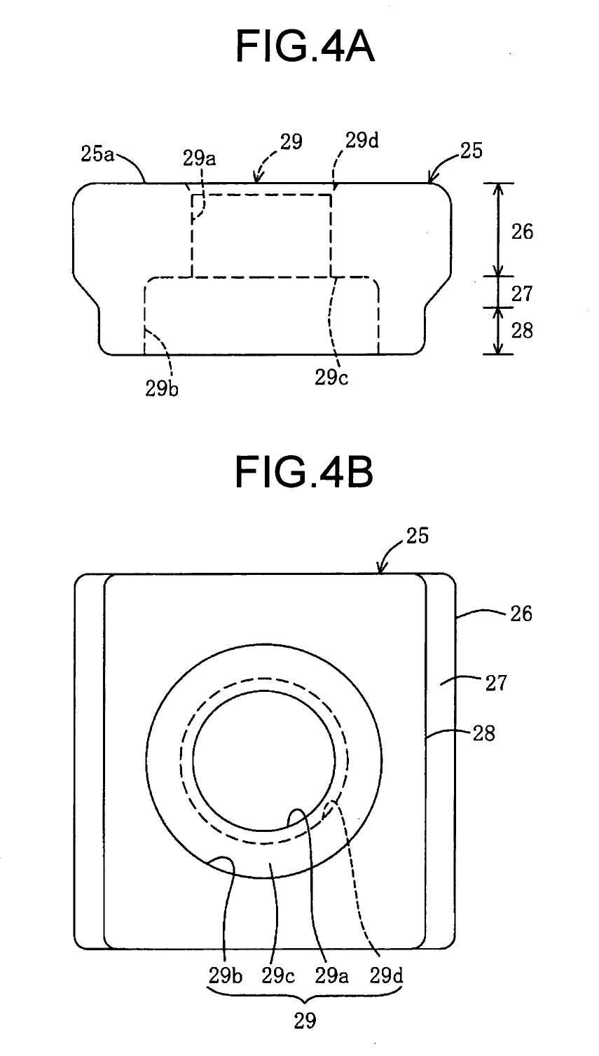

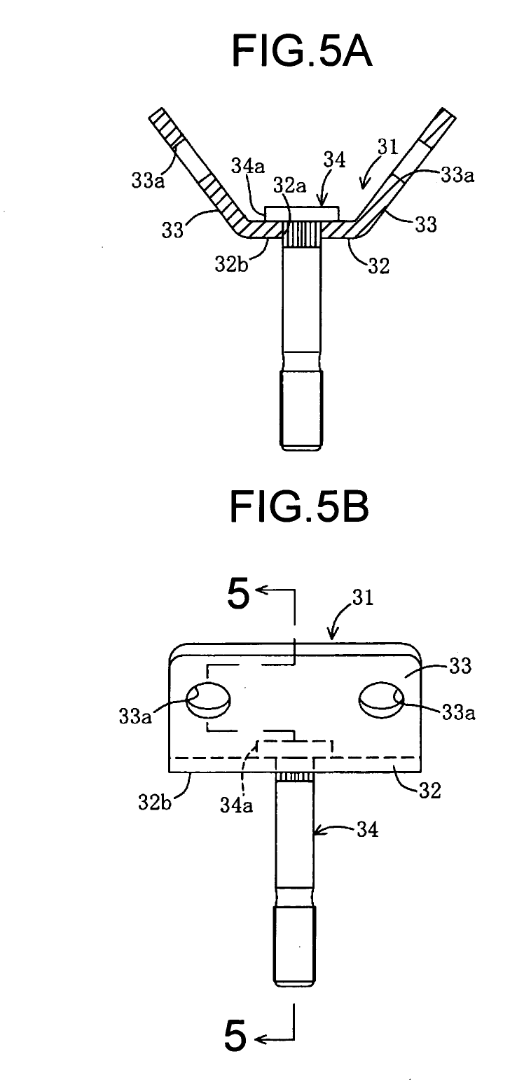

There will be described preferred embodiments of the present invention with reference to the drawings. FIGS. 1 and 2 is a first embodiment and show a cross sectional and side view of a dynamic damper 10 installed and used in an automobile transmission. FIG. 3 is a cross sectional view of the dynamic damper 10 comprising a rubber bushing 11. FIG. 4 is a front bottom view of the dynamic damper 10 comprising an outer cylinder mass in the form of a metallic mass member 25. FIG. 5 shows a front and side view of a bracket in the form of a mounting member 31 on the transmission-side as a object member.

The dynamic damper 10 includes: a rubber bushing 11 constituted by a metallic inner sleeve 12, a cylindrical sleeve in the form of a metallic outer sleeve 15 disposed coaxially about the inner sleeve 12 with a spacing therebetween, and a rubber elastic body 21 disposed in between and elastically connecting the inner and outer sleeves 12, 15; and the metallic mass member 25 of cylindrical configuration that is externally fitted onto an outer circumferential surface of the outer sleeve 15 of the rubber bushing 11. The mounting member 31 is inserted through a bore 12a of the inner sleeve 12. That is, the first embodiment provides a separated-type mass member in which the outer sleeve 15 serves as the cylinder sleeve, while the mass member 25 is the outer cylinder mass, and the two are put together to function as a mass member. In the following description, each part of the dynamic damper 10 in terms of vertical, left-right, and front-back directions are oriented in FIG. 1 as they would be in the installed condition in an automotive vehicle (the front plane of FIG. 1 corresponds to the rear of the vehicle).

As shown in FIG. 3, the inner sleeve 12 has a straight cylindrical body 13 and an annular flange 14 that extends in the radial direction and is affixed to one end in the axial direction (top end in the drawing). The outer sleeve 15 has a body 16 that is a thin-walled cylindrical shape and shorter in the axial direction than the body 13 of the inner sleeve 12. At one end of this body 16 in the axial direction, an annular rim part 17 is formed as one integral part extending in the radial direction. A bent part 18 is formed as one integral part extending slightly toward the central axis at the other axial end (the bottom and in the drawing). The annular rim part 17 has an outer diameter generally similar to that of the flange 14. The outer sleeve 15 may be formed of a metallic pipe member processed by pressing or drawing operation.

The rubber elastic body 21 fills the space defined between the body 13 and flange 14 of the inner sleeve 12 and the body 16 and rim part 17 of the outer sleeve 15, thereby elastically connecting both sleeves 12 and 15. The rubber elastic body 21 includes a cylindrical part 22 interposed between the bodies 13, 16 of the inner and outer sleeves 12, 15, and an annular part 23 interposed between the flange 14 and the rim part 17. The rubber elastic body 21 is formed through vulcanization of a rubber material for forming thereof in a mold where the inner sleeve 12 and the outer sleeve 15 are set in position. Thus, the rubber bushing 11 as a component of the dynamic damper 10 is formed as a rubber vulcanized-formed product, as shown in FIG. 3.

The mass member 25 shown in FIG. 4 is a thin-walled square block form, and when viewed in plan, it has an approximately square shape top part 26 running from the top surface 25a in between in the thickness direction. In the intermediate point in the thickness direction, an intermediate part 27 having a sloped surface that slopes at an approximately 45° angle from the left and right sides toward the lower inside. In short plan view, this lower side has a lower side part 28 that is rectangular in between the left and right sides. In the center of the mass member 25, a circular through-hole 29 is provided running in the vertical direction (thickness direction). The through-hole 29 comprises an upper whole part 29a provided in the upper side part 26, and a lower hole part 29b provided in the intermediate part 27 and the lower side part 28. The inner diameter of the upper hole part 29a is slightly smaller than the diameter of the outer sleeve 15 body 16, and the outer sleeve 15 is firmly fixed by inserting it into the upper whole 29a. The lower hole part 29b as a diameter larger than that of the upper whole part 29a, and the boundary between the two forms the step part 29c that extends in the radial direction. Moreover, the top surface 25a of the upper hole part 29a widens in a tapered surface shape toward the top surface 25a to form the tapered surface 29d. A dynamic damper is obtained by inserting the rubber bushing 11 into the upper hole part 29a of the through hole 29 from the top surface 25a of the mass member 25 at the bent part 18 side of the outer sleeve 15.

The mounting member 31 includes a mounting plate part in the form of a rectangular center plate part 32 and a pair of sloping plate parts 33 located at opposite end of the center plate part 32 while being bent and sloped at an approximately 45° angle along the length of the center plate part 32. The center plate part 32 and the sloping plate part 33 are short in the connecting direction, while the width in the direction perpendicular to the connecting direction is long. The connecting direction length of the center plate part 32 is smaller than the outer diameter of the flange 14 and larger than the outer diameter of the body 13 of the inner sleeve 12. Also, the length in the width direction of the center plate part 32 is larger than the outer diameter of the flange 14. The center plate part 32 has an installation hole 32a located in its center, and the opposite surface relative to the sloping plate part 33 has an attachment surface 32b upon which the flange 14 of the inner sleeve 12 is installed. A fixing member in the form of a bolt 34 is inserted through the installation hole 32a with its head part 34a positioned on the side where the sloping plate parts 33 are bent. This head part 34a is locked by the installation hole 32a, and fixed in place on the center plate part 32 by welding or other method. Furthermore, pairs of installation holes 33a are provided near the ends of both sloping plate parts 33 in the width direction. Annular shaped thin metal locking ring 35 is provided at the tip end of the bolt 34 of the mounting member 31, and nut 36 is screwed thereon. The inner diameter of the locking metal ring 35 is approximately the same as that of the outer shape of the bolt 34, and the outer diameter is larger than the inner diameter of the upper hole part 29a of the mass member 25.

Following is a description of the assembly of the dynamic damper 10. The bolt 34 of the mounting member 31 is inserted into the shaft hole 12a of the inner sleeve 12 from the flange 14 side relative to the rubber bushing 11, and the nut 36 is screwed onto the tip end of the bolt 34 with the locking metal ring 35 interposed therebetween. Thus, the mounting member 31 is assembled with the inner sleeve 12. Since the outer diameter of the locking metal ring 35 is larger than the inner diameter of the upper hole part 29a of the mass member 25, the rubber bushing 11 is prevented from entirely falling out from the mass member 25, even if the outer sleeve 15 comes out of the mass member 25. On the other hand, the sloping plate parts 33 of the mounting members 31 installed on the dynamic damper 10 are fixed to the transmission 1 as the object member by means of bolts or other fastening member (not shown) inserted through the installation holes 33a. Thus, the dynamic damper 10 is installed on the transmission 1 with its axial direction oriented to the up-and-down direction of the vehicle.

In the dynamic damper 10 of construction according to the first embodiment as described above, the flange 14 is provided at one axial end of the inner sleeve 12 and extending in the radial direction, and the outer rim of the attachment surface 32b of the mounting member 31, which contacts this flange 14, is larger than the outer diameter of the body 13 of the inner sleeve 12 and encloses it. With this arrangement, the contacting surface area between the flange 14 and the attachment surface 32b is made large, so that the inner sleeve 12 is firmly fixed to the attachment surface 32b of the mounting member 31. As a result, the inner sleeve 12 is supported on the side of the transmission 1 with increased strength with respect to lateral stress due to the horizontal input vibration of the vehicle. This makes it possible to avoid undesirable reduction of the resonance frequency of the dynamic damper relative to the input vibration in the lateral direction, whereby the preset high-frequency setting of the resonance frequency of the dynamic damper is effectively maintained, and the lateral direction high-frequency input vibration are effectively suppressed. Accordingly, the dynamic damper of construction according to the present invention is capable of affording bi-directional resonance frequencies at preset appropriate levels for the lateral direction in addition to the vertical direction of the vehicle, thereby appropriately attenuating vertical as well as lateral high-frequency input vibration to the vehicle, thus contributing to a significant increase in vehicle quietness.

While the combined weight of the mass member 25 and the outer sleeve 15 serving as the mass member is extremely large in this dynamic damper 10, it is divided into an extremely lightweight outer sleeve 15 and a mass member 25 installed on the outer perimeter of the outer sleeve that has a high mass. Thus, since it is acceptable to insert the rubber bushing 11 into the mass member 25 after vulcanized formation of the rubber elastic body 21 interposed between the inner sleeve 12 and the lightweight outer metal sleeve 15, the vulcanized forming of the rubber elastic body 21 is extremely simple. As a result, the overall manufacturing process for the dynamic damper in the first embodiment is simplified, including the installation of the outer sleeve 15 and the mass member 25, making it possible to provide the dynamic damper 10 with a relatively low cost.

Furthermore, the outer diameter of the flange 14 is larger than the inner diameter of the body 16 of the outer sleeve 15, and the inner rim of the body 16 is enclosed by the outer rim of the flange 14. With this arrangement, the flange 14 of the dynamic damper 10 and the attachment surface 32b of the mounting member 31 can be held in contact with each other with a large contact surface area. As a consequence, the dynamic damper 10 is capable of affording further increased ability to damp lateral high-frequency input vibration due to the increased strength in relation to lateral stress of the inner sleeve 12.

Moreover, in this dynamic damper 10, the compressive deformation properties of the rubber elastic body 21 can be used in addition to its shear deformation properties since the rubber elastic body 21 is provided interposed between the opposing surfaces of rim part 17 of the outer sleeve 15 and the flange 14. Thus it is possible to adjust the spring constant of the rubber elastic body 21 within a wider range. This makes it possible for the dynamic damper 10 to more effectively adjust to suppress the vertical and lateral vibration of the vehicle. Also, the dynamic damper 10 is able to adjust its resonance frequencies with respect to vertical and lateral input vibration to different frequency bands, thus performing the appropriate amount of attenuation of vehicle vertical and lateral input vibration, resulting in enhanced vehicle quietness.

In this dynamic damper 10, as shown in FIG. 1, a gap A is formed behind the center plate part 32 of the mounting member 31 for accommodating the head portion head part 34a of the bolt 34, and the strength of the center plate part 32 is decreased. However, the presence of the flange 14 will reinforce the strength of the center plate part 32 in addition to increase the contacting surface area between the flange and the attachment surface, thus effectively increasing strength of the inner sleeve relative to lateral load applied thereto. Moreover, this flange 14 superimposed on the center plate part 32 cooperates with the rim part 17 to compress therebetween the annular part 23 of the rubber elastic body 21. This makes it possible to provide a mechanism at the basal end of the inner sleeve 12, utilizing compressive component of the rubber elastic body, without exerting large moment on the basal end of the inner sleeve.

More specifically, the mounting member 31 has edge parts between the central plate part 32 and the opposite sloping plate parts, in order to reinforce thereof, and the edge is situated radially outward of the outer rim of the axial end of the inner sleeve, while the flange 14 superimposed on the central plate part 32 extends outwardly excess the edge parts. With this arrangement, the rigidity or strength created by the edge parts of the mounting member 31 can be effectively utilized so that the mounting member 31 can supports the inner sleeve 12 with enhanced supporting strength against the lateral load.

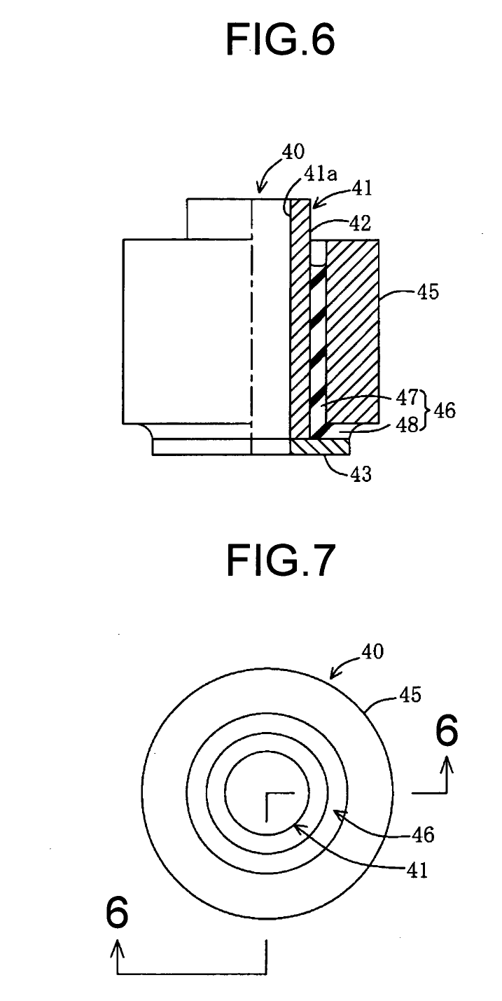

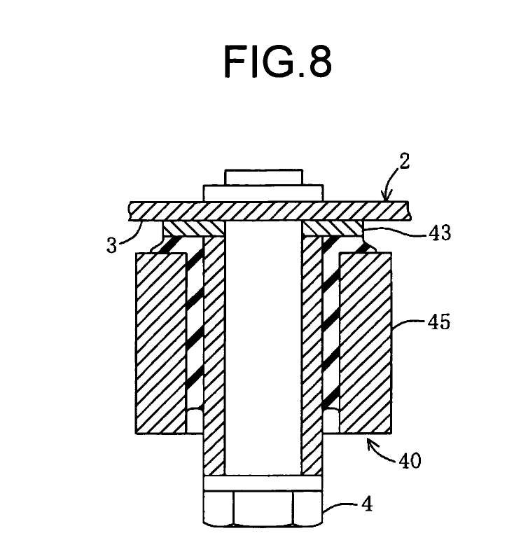

Following is a description of a second embodiment of the invention. FIGS. 6 and 7 show a partial cross-section and a plan view of a second embodiment, which is a dynamic damper 40 installed on a center bearing support 2 in the propeller shaft area of a vehicle. FIG. 8 shows a cross sectional view of the dynamic damper 40 in the installed condition on the center bearing support 2. The dynamic damper 40 comprises an inner sleeve 41, a cylindrical mass member 45 coaxially disposed about the inner sleeve 41, and the rubber elastic body 46 interposed between and elastically connecting the inner sleeve 41 and the mass member 45.

The inner sleeve 41, like the inner sleeve 12 described above, has a straight cylindrical body 42 and an annular flange 43 that extends in the radial direction and is affixed to one end in the axial direction. The mass member 45 is a thick-walled cylinder metal fitting, and its inner diameter is smaller than the inner diameter of the flange 43, and the outer diameter is larger than the outer diameter of the flange 43. Moreover the mass member 45 has a length in the axial direction shorter than the length in the axial direction of the inner sleeve 12. The space defined between the body 42 and flange 43 of the inner sleeve 41, and an inner circumferential surface of the mass member 45 and one end in the axial direction (bottom of the drawing), is filled with the rubber elastic body 46 so that the inner sleeve 41 and the mass member 45 are elastically connected. The rubber elastic body 46 includes a cylinder part 47 interposed between the body 42 and the inner circumferential surface of the mass member 45, and an annular part 48 interposed between the flange 43 and one axial end of the mass member 45. The rubber elastic body 46 is formed through vulcanization of a rubber material for forming thereof in a mold where the inner sleeve 41 and the mass member 45 are set in position. Thus, the rubber elastic body 46 is formed as a unit with both inner sleeve 41 and the mass member 45, thereby forming the dynamic damper 40.

As shown in FIG. 8, this dynamic damper 40 is disposed in its axial direction vertical to the flat attachment surface 3 of the center bearing support 2 as an object member. The flange 43 superimposes the attachment surface 3, and the lower end of the inner sleeve 41 is affixed to the attachment surface 3 by means of a bolt 4 that is inserted through the shaft hole 41a.

In the second embodiment as constituted above, the dynamic damper 40 is provided with a flange 43 that extends radially outwardly from one end of the inner sleeve 41 in the axial direction. The outer rim of the attachment surface 3, which is held in contact with the flange 43, is made larger than and surrounds the outer rim of one end of the body 42 of the inner sleeve 41. Thus, the inner sleeve 41 is firmly affixed to the attachment surface 3 of the center bearing support 2, and is supported by the center bearing support 2 such that it has increased strain relative to lateral stress from horizontal input vibration. As a result, decreases in the reduction of resonance frequency of the dynamic damper 40 relative to vehicle lateral input vibration are prevented, and the preset high-frequency setting of the resonance frequency of the dynamic damper is effectively maintained. Accordingly, the dynamic damper of construction according to the present invention is capable of affording bi-directional resonance frequencies at preset appropriate levels for the lateral direction in addition to the vertical direction of the vehicle, thereby appropriately attenuating vertical as well as lateral high-frequency input vibration to the vehicle, thus contributing to a significant increase in vehicle quietness, as in the first embodiment.

In the second embodiment, the dynamic damper 40 has the flange 43 with an outer diameter that is larger than the inner diameter of the mass member 45. Further, the inside rim of the mass member 45 is enclosed by the outer rim of the flange 43, so that the contact surface area between the flange 43 and the attachment surface 3 of the object member is increased. As a result, as in the case of the second embodiment, the strength of the inner sleeve 41 in relation to lateral stress is increased, whereby the ability of the dynamic damper 40 to attenuate lateral vibrations is increased. In this dynamic damper 40, moreover, an annular part 48 of the rubber elastic body 46 is provided extending as far as the space between the opposite surfaces of the mass member 45 and the flange 43, thereby enabling a still wider adjustment range for the spring constant of the rubber elastic body 46. Thus, as in the case of the second embodiment, the dynamic damper 40 permits a wide range of adjustments in its damping performance with respect to vertical as well as lateral vibration inputs of the vehicle.

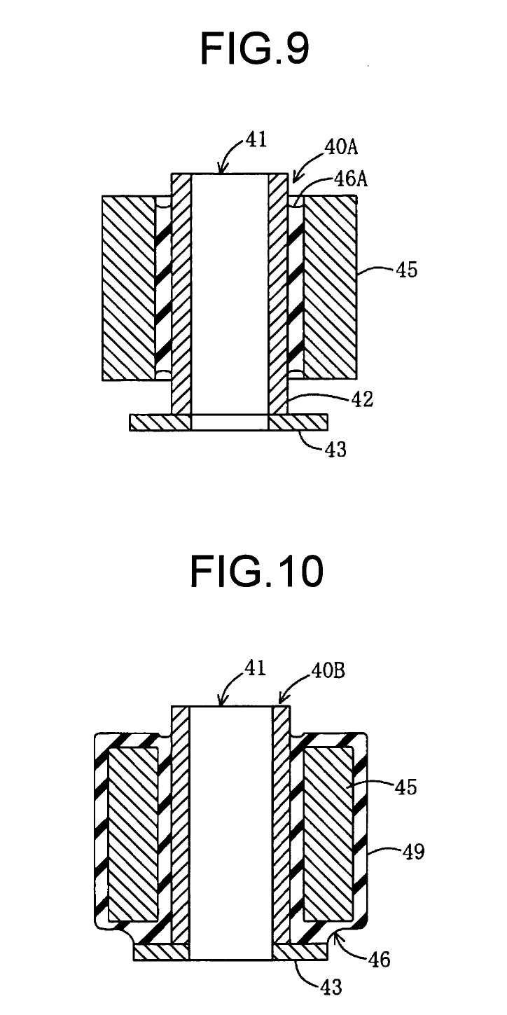

FIG. 9 shows a modification of the second embodiment described above. In place of the rubber elastic body 46, a rubber elastic body 46A is provided only in the cylindrical part defined between the body 42 and the inner circumferential surface of the mass member 45, but is not provided in the area defined between one axial end face of the flange 43 and the mass member 45. By eliminating the rubber elastic body 46A at the area defined by one axial end face of the flange 43 and the mass member 45, the compressive component of the rubber elastic body 46A is not utilized. However, since the contact surface area between the flange 43 and attachment surface 3 of the center bearing support 2 is expanded, there is similarly obtained the effect of increasing strength of the inner sleeve 41 with respect to lateral stress, thereby increasing the ability of the dynamic damper 40A suppress lateral vibrations. Therefore, the modification of the dynamic damper 40A shown in FIG. 9 may be used.

The following is a description of a third embodiment of the invention. In this third embodiment, the constitution of the rubber elastic body used in the second embodiment of the dynamic damper 40 is changed. FIG. 10 shows a dynamic damper 40B of construction according to the third embodiment of the invention. The dynamic damper 40B includes an inner sleeve 41, a cylindrical mass member 45 disposed coaxially about the inner sleeve 41, and an elastic rubber part 46 interposed between and elastically connects the inner sleeve 41 and the mass member 45. In the dynamic damper 40, an outer part of the mass member 45, which is not coated with the rubber elastic body 46, is coated by a thin rubber coating layer 49. Moreover, the rubber elastic body 46 and the rubber cylinder part 49 are non-adhering with the mass member 45.

In the third embodiment as constituted above, like in the aforementioned second embodiment, a vehicle's lateral input vibration can be attenuated in addition to vertical input vibration, effectively increasing vehicle quietness. Moreover, since the rubber elastic body 46 and the rubber coating layer 49 are non-adhering relative to the mass member 45, adhesive processing steps to the metal fitting can be omitted, thereby simplifying rubber vulcanization forming and reducing dynamic damper manufacturing costs.

While, in the illustrated embodiments, the rubber elastic body is disposed between the members with no gap provided therein, penetrating spaces in the axial direction may be provided at the appropriate locations in the rubber elastic body, thereby permitting tuning of the spring constant in the front-to-back and left-to-right directions of the rubber elastic body. This makes it possible to appropriately adjust vibration-damping performance of the dynamic damper with respect to input vibration. Furthermore, the shape of the dynamic damper of this invention is not limited to the specific ones of the embodiments described above, and the inner sleeve, the mass member, the rubber elastic body, the mounting members may have a variety of shapes, for example. Additionally, while the preferred embodiments has been described for the illustrative purpose only, it should be understood that the present invention may be embodied with various other changes, modifications and improvements, which may occur to those skilled in the art, without departing from the spirit and scope of the invention defined in the following claims.

The dynamic damper of this invention can effectively attenuate bi-directional input vibration and contribute to a significant increase in vehicle quietness by permitting adjustment of the resonance characteristics of the bi-directional input vibration of a vehicle in the vertical and lateral directions.

1. A dynamic damper comprising:
an inner sleeve adapted to be mounted at one axial end thereof on a flat attachment surface of an object member,
a cylindrical mass member disposed coaxially about the inner sleeve with a spacing therebetween;
a rubber elastic body interposed between and elastically connecting the inner sleeve and the mass member; and
an annular flange extending radially outwardly from the one axial end of the inner sleeve,
wherein when the dynamic damper is mounted on the attachment surface, an outer rim of the one axial end of the inner sleeve is surrounded by an outer rim of an area of the attachment surface where is superimposed with the flange.

2. A dynamic damper according to claim 1, wherein the mass member comprises a lightweight cylinder sleeve and an outer cylinder mass having a greater weight than does the cylinder sleeve, and externally fitted onto the cylinder sleeve.

3. A dynamic damper according to claim 1, wherein an inner rim of the mass member may be surrounded by an outer rim of the flange.

4. A dynamic damper according to claim 3, wherein the rubber elastic body is interposed between opposing surfaces of the mass member and the annular flange.

5. A dynamic damper according to claim 1, wherein an entire outer surface of the mass member is coated with a rubber coating layer, and the mass member is made non-adhering with the rubber elastic body and the rubber coating layer.

6. A dynamic damper according to claim 1, wherein the dynamic damper is arranged such that the resonance frequencies in axial and axis-perpendicular directions thereof are tuned to different frequencies.

7. A dynamic damper according to claim 1, further comprising a mounting member for mounting the dynamic damper on the object member, the mounting member including a mounting plate part having a hole perforated therethrough, wherein the flat attachment surface is provided on one side of the mounting plate part, and a gap is formed on an other side of the mounting plate part for accommodating a head of a fixing member extending through the hole of the mounting plate part and an inner bore of the inner sleeve for affixing the inner sleeve onto the flat attachment surface provided by the mounting plate part of the mounting member, and the annular flange is superimposed on the attachment surface provided by the mounting plate part of the mounting member.
